(19) United States
(12) Patent Application Publication
(10) Pub. No.: US 2026/0038303 A1
(43) Pub. Date: Feb. 5, 2026

(54) OPERATION PERFORMANCE BASED ON EYELASH MOVEMENT OF AN IDENTIFIED USER

(71) Applicant: Infineon Technologies AG, Neubiberg (DE)

(72) Inventor: Hannes Plank, Graz (AT)

(21) Appl. No.: 19/281,076

(22) Filed: Jul. 25, 2025

(30) Foreign Application Priority Data
Jul. 30, 2024 (DE) 102024121635.2

(51) Int. Cl. G06V 40/20; G06F 3/01; G06V 40/16

(52) U.S. Cl. CPC G06V 40/20; G06F 3/013; G06V 40/172

(57) ABSTRACT

Apparatus having one or more processors configured to receive images of a face of a user and to use the images to identify whether a user is an approved user, and, if the user has been identified as an approved user, to determine an eyelash movement characteristic of the user from the images and to perform an operation according to the determined eyelash movement characteristic of the user.

### TECHNICAL FIELD

The aspects of the disclosure relates to user control by means of an eyelash movement characteristic.

### BACKGROUND

Access controls, for example to buildings or rooms, but also to smartphones, computers or other computer-based devices or installations, as well as vehicles, are increasingly equipped with electronic security systems. These can be, for example, security systems with fingerprint sensors, face/iris recognition or those with readers for electronic cards or smartphones.

For example, face/iris recognition uses a system with one or more cameras that captures the face and/or iris and compares specific characteristics of the face and/or iris with the data/characteristics stored in a background system. Access is granted as of a certain, previously defined, degree of conformity of the data/characteristics stored in a background system with the captured characteristics.

In order to increase security and/or for user control, an eyelash movement characteristic can also be captured and processed in such a face/iris recognition system.

### SUMMARY

An apparatus for user control by means of an eyelash movement characteristic and a method for user control by means of an eyelash movement characteristic are provided. Further exemplary aspects are described.

### BRIEF DESCRIPTION OF THE DRAWINGS

Exemplary aspects of the disclosure are illustrated in the figures and are explained in more detail below.

In the figures:

FIG. 1A shows an exemplary aspect of an apparatus having user control by means of an eyelash movement characteristic; and

FIG. 1B shows a detailed view of the exemplary aspect from FIG. 1A.

### DETAILED DESCRIPTION

In the detailed description that follows, reference is made to the accompanying drawings, which form part of said description and show, for illustration, specific aspects in which the disclosed aspects may be performed. In this regard, direction terminology such as, for instance, “at the top”, “at the bottom”, “at the front”, “at the back”, “front”, “rear”, etc. is used with respect to the orientation of the figure(s) described. Since components of aspects may be positioned in a number of different orientations, the direction terminology is used for illustration and is not restrictive in any way. It goes without saying that other aspects may be used and structural or logical changes may be made, without departing from the scope of protection of the present aspects of the disclosure. It goes without saying that the features of the various exemplary aspects described herein may be combined with one another, unless specifically stated otherwise. The detailed description that follows should therefore not be interpreted in a restrictive sense, and the scope of protection of the present aspects of the disclosure is defined by the attached claims.

Within the scope of this description, the terms “connected” and “coupled” are used to describe both a direct and an indirect connection and direct or indirect coupling. In the figures, identical or similar elements are provided with identical reference signs if expedient.

An apparatus and a method for user control by means of an eyelash movement characteristic are shown in various exemplary aspects.

The apparatus has one or more processors which are configured to receive images of a face of a user. This can be effected, for example, using one or more cameras. Images or facial characteristics stored in a background system can be used to identify a user and to determine whether or not the user is approved and thus has access authorization. The images are first digitized in a computer system. Recognition software then locates the faces and calculates the characteristic properties. The result of this calculation, the so-called template, is compared with the templates of the stored facial images.

There are different approaches to face recognition, all of which use certain core elements. In most face recognition methods, characteristic features of the facial features are determined using a digitized image. Use is made, in particular, of those features of the face which do not constantly change due to facial expressions, i.e. the upper edges of the eye sockets, the areas around the cheekbones and the side parts of the mouth.

As a rule, the characteristic facial features are compared with the corresponding reference features using conventional image processing and image analysis methods. For example, once the eyes have been located, the facial features are calculated using a grid that is placed over the face.

The user can also be identified in a similar manner by means of an eye or an iris of the user.

In face, eye or iris recognition, the eyelashes are also located using a plurality of reference points and are digitized in the computer system.

The eyelash movements, the so-called eyelash movement characteristic, are determined based on the images recorded during face, eye or iris recognition (image sequence).

In a similar manner to face recognition, various eyelash movement characteristics are also stored digitally, as reference variables, in the background system.

If a user is approved, the eyelash movement characteristic of the user from the captured images can be used to perform an operation according to the determined eyelash movement characteristic of the user. The different eyelash movement characteristics are assigned to one or more operations in the background system.

The eyelash movement characteristic of the user from the captured images can be generated by the user in the form of a blinking pattern of the user or by way of a code using different eye closing times. This eyelash movement characteristic is compared with the eyelash movement characteristics stored (i.e. saved) in the background system and, if there is conformity, an operation is carried out according to the determined eyelash movement characteristic of the user.

For example, the operation can be a control operation for controlling a device, an installation or a vehicle.

In a further exemplary aspect, the operation may be, for example, an additional security operation for further checking the identity/verification of the user, keyword two-factor authentication.

In a further exemplary aspect, the operation may be, for example, an operation for generating an alarm message.

This operation can be used, for example, if the apparatus is an access system, specifically an electronic door or another electronic lock. If, for example, the user is harassed by a third party during the opening process or has a medical emergency, he can simply and unnoticeably transmit an emergency call/alarm message using an eyelash movement characteristic stored in the system. In response to the emergency call/alarm message, access can be ultimately blocked or appropriate help can be requested via a security center. In this case, the eyelash movement characteristic serves as a kind of panic button.

In further exemplary aspects, the apparatus may be a smartphone, a computer or a (mobile) computer-based apparatus.

Two-factor authentication can also be carried out or one or more programs can be started by means of the eyelash movement characteristic, for example a special blinking code.

In a further exemplary aspect, the apparatus can also be used in a vehicle, for example in a cockpit/control center of an automobile or an aircraft or a ship. This is useful since more and more vehicles are equipped with camera systems. An eyelash movement characteristic could be used to control functions or activate emergency call functions in these application examples. Of course, in these apparatuses, the security of access can also be increased by further authentication of the user.

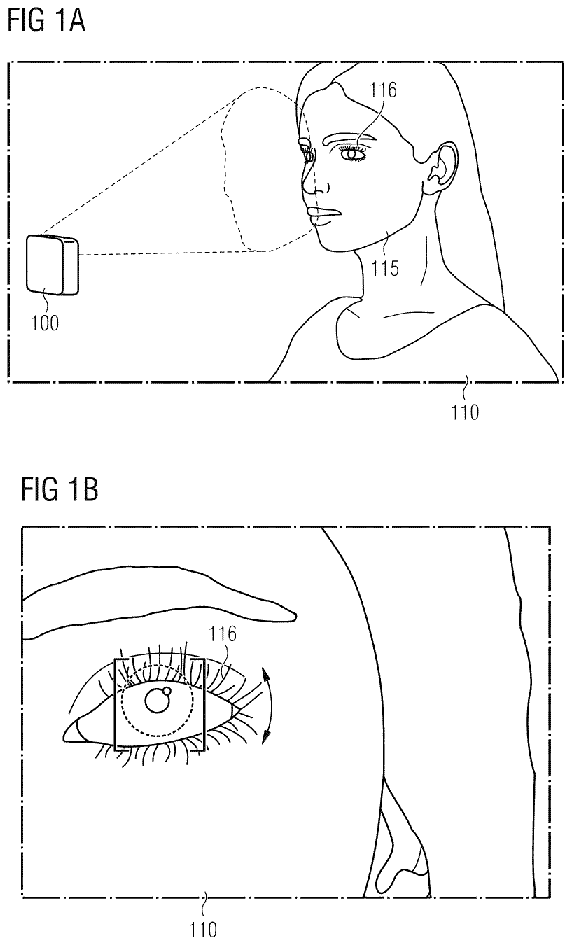

FIG. 1A shows an exemplary aspect of an apparatus 100 having user control by means of an eyelash movement characteristic 116, wherein a sequence of images of a face 115 of a user 110 are captured by a camera system 120 (for example a camera) to identify whether the user 110 is an approved user 110. If the user 110 has been identified as an approved user 110, an eyelash movement characteristic 116 of the user 110 is determined from the captured images. According to the eyelash movement characteristic 116 of the user 100, an operation (which is represented by the eyelash movement characteristic 116 of the user 100) is carried out.

This operation can be, for example, a further security operation, for example two-factor authentication/verification or an alarm function, for example if the user 110 is harassed by a third party when entering a room/building or suffers a medical emergency. An alarm function can be used, for example, to activate additional safeguards or to alert emergency personnel via an emergency call. The emergency personnel can be alerted using the known means such as a control center, SMS, e-mail or calling stored numbers.

FIG. 1B shows in detail the eyelash area in a face 115 of the user 110. Various operations can be initiated by means of the eyelash movement characteristic 116 (e.g. a movement (for example a movement trajectory) of the eyelashes of the user 110 in the captured sequence of images). These operations are assigned to the respective eyelash movement characteristic 116 in a background system.

The eyelash movement characteristic 116 can be realized, for example, by blinking or in the form of a predefined code by means of different eye closing times.

An artificial intelligence (AI) program (a program that implements a trained “artificial intelligence” model) that is executed in the background on a computer can be used by the system to determine and process different eyelash movement characteristics 116 of different users 110 and to learn to optimize itself. The AI-based approach can be used to significantly improve the accuracy and reliability of such an apparatus.

1. An apparatus, comprising:
a memory configured to store reference data related to eyelash movement characteristics; and
one or more processors communicatively coupled with the memory and configured:
to receive images of a face of a user;
to use the images to identify whether a user is an approved user;
if the user has been identified as an approved user, to determine an eyelash movement characteristic of the user from the images; and
to perform an operation according to the determined eyelash movement characteristic of the user.

2. The apparatus as claimed in claim 1, wherein the processor(s) is/are configured to receive images of an eye or an iris of the user.

3. The apparatus as claimed in claim 1, wherein the eyelash movement characteristic of the user is a predefined blinking pattern of the user.

4. The apparatus as claimed in claim 3, wherein the blinking pattern of the user has a predefined eye closing time.

5. The apparatus as claimed in claim 1, wherein the apparatus is a smartphone or a computer.

6. The apparatus as claimed in claim 1, wherein the apparatus is an electronic cockpit in a vehicle.

7. The apparatus as claimed in claim 1, wherein the apparatus is an access system.

8. The apparatus as claimed in claim 7, wherein the access system is an electronic door or an electronic flap with an electronic lock.

9. The apparatus as claimed in claim 1, wherein the operation is a control operation for controlling a device or an installation.

10. The apparatus as claimed in claim 1, wherein the operation is a security operation for further checking the identity of the user.

11. The apparatus as claimed in claim 1, wherein the operation is an operation for generating an alarm message or an emergency call message.

12. A method for user control using an eyelash movement characteristic, comprising:
receiving images of a face of a user using a camera;
using the images to identify in a computer-controlled system whether a user is an approved user;
determining an eyelash movement characteristic of the user from the images when the user has been identified as an approved user; and
performing an operation according to the determined eyelash movement characteristic of the user.

13. The method as claimed in claim 12, further comprising:
generating an alarm message or emergency call message according to the determined eyelash movement characteristic of the user.

14. The method as claimed in claim 12, further comprising:
generating a control operation for controlling a door opening system, an electronic device, a computer-based installation, a computer system, or a vehicle according to the determined eyelash movement characteristic of the user.

15. The method as claimed in claim 12, further comprising:
performing an additional check of the identity of the user according to the determined eyelash movement characteristic of the user.
